(19) United States
(12) Patent Application Publication
(10) Pub. No.: US 2002/0153649 A1
(43) Pub. Date: Oct. 24, 2002

(54) Automatic transmission with a hydraulic system

(76) Inventors: Michael Weber, Waldburg (DE); Bernd Fessler, Kressbronn (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 10/076,765

(22) Filed: Feb. 14, 2002

(30) Foreign Application Priority Data
Feb. 20, 2001 (DE) 101 07 854.4

(51) Int. Cl. F16F 7/00

(52) U.S. Cl. 267/217

(57) ABSTRACT

The automatic transmission described has a hydraulic system (1) for control and regulation of a hydrodynamic retarder (6) which has a retarder space (9) formed between a rotor (7) and a stator (8). A degree of admission of the retarder space (9) can be altered according to a position of a hydraulic ratio (10, 11, 12) connected with the retarder space (9).

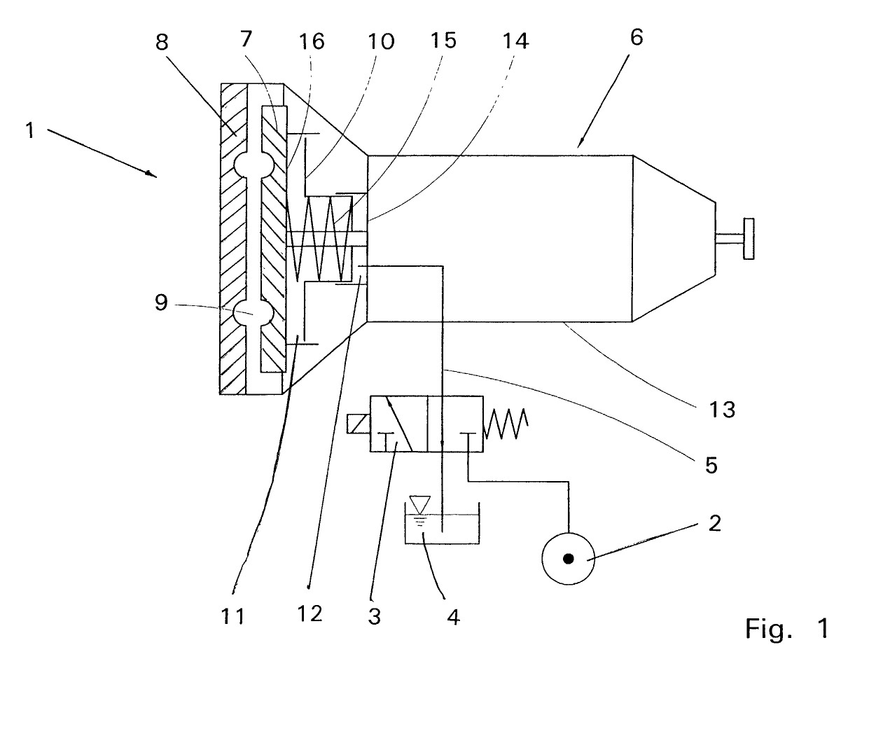

The invention concerns an automatic transmission with hydraulic system of the kind defined in detail in the preamble of claim 1.

From the practice automatic transmissions for vehicles are known , especially industrial vehicles and city autobuses, having a retarder which as primary retarder, for example, is situated between a hydrodynamic converter and the main transmission in a drive chain of the vehicle. For the control of a hydrodynamic retarder, pneumatic systems are used which are supplied with compressed air via a compressed air system existing in the vehicle.

It is also known to carry out the control of the retarder, via a hydraulic system, combined with a pneumatic system. Determined by its structural conditions, the retarder, because of its relatively great charge volume, cannot be controlled only via a known hydraulic system, since a response behavior needed in the operation of the brake or in case of a braking demand is not quick enough with a pump inside the transmission in view of dynamics, i.e., a ratio of filling time and pump feed capacity. It would thus be impossible to engage the retarder within the time required. For this reason, a pneumatically controlled pressure reservoir is attached in a hydraulic control of the hydrodynamic retarder, via an additional pneumatic system.

In an exclusive hydraulic control of the retarder, in the designs known from the practice an increase of the pump feed capacity is needed which disadvantageously results in a reduction of the total efficiency. Especially for increasing its feed capacity, the pump must be made with larger dimensions, which leads to a heavier total weight of the transmission and also requires substantially more installation space.

On the other hand, a pneumatically assisted hydraulic control disadvantageously requires an additional pressure reservoir and an air connection to a compressed air system of the vehicle. This involves a considerable application cost which adds to the system expenses of an automatic transmission. Besides, in a pneumatically assisted hydraulic control, a different dynamic behavior results, depending on the degree of admission for the hydraulic pressure reservoir, whereby the control and regulation are made considerably more difficult.

In the case of an exclusively pneumatic control of a hydrodynamic retarder, a hydraulic circuit of the retarder has to be sealed airtight from the main transmission so that a higher sealing expense must be incurred which also results in an increase of the production costs.

The problem on which this invention is based is to make an automatic transmission available having a hydraulic system with which a hydrodynamic retarder can be controlled and regulated hydraulically absolute and which involves only low production costs.

According to the invention this problem is solved with an automatic transmission according to the features of claim 1.

With the inventive automatic transmission having a hydraulic system for control and regulation of a hydrodynamic retarder whose retarder space is formed between a rotor and a stator, a filling ratio of the retarder space is advantageously altered according to a position of the hydraulic ratio connected with the retarder space.

In the inventive configuration of the hydraulic system with a hydraulic ratio which allows moving a large hydraulic amount with a small hydraulic control amount, an absolute hydraulic control and regulation of a hydrodynamic retarder is accomplished with simple means without separate pressure reservoir having to be provided.

In addition, a pressure source or a pump of the automatic transmission can be made smaller than in an absolute hydraulic control and regulation with a known hydraulic system whereby a considerable saving in installation space is achieved with the proposed hydraulic system.

In a very advantageous development of the invention, it is provided that the hydraulic ratio be designed with a step piston which defines a first piston space with larger bottom surface and a second piston space with smaller bottom surface, the first piston space being connected with the retarder space and preferably bordering on the side of the rotor remote from the retarder space. In this manner the hydraulic ratio can be implemented easily and at reasonable cost.

Other advantages and developments of the invention result from the claims and from embodiments fundamentally described with reference to the accompanying drawing.

The single figure of the drawing shows a hydrodynamic retarder and part of a hydraulic system of an automatic transmission by which a step piston of the retarder can be controlled and/or regulated.

Sown in the figure of a hydraulic system 1, the part has a pressure source in the form of a pump 2, a valve 3 and an oil reservoir 4. The hydraulic system 1 is connected with a hydrodynamic retarder 6 via a pipe 5. The retarder 6 has a retarder space 9 formed between a rotor 7 and a stator 8. Upon the side of the rotor 7, remote from the retarder space 9, a step piston 10 is provided which movably placed in axial direction of the retarder 6 defines a first piston space 11 of large bottom surface and a second piston space 12 of smaller bottom surface.

The second piston space 12 is connected, via the pipe 5, with the hydraulic system 1 while the first piston space 11 has a connection with a retarder space 9. The step piston 10 forms, together with the piston spaces 11 and 12, a hydraulic ratio by which the degree of admission of the retarder space 9 can be altered, according to an axial position of the step piston 10.

When the hydrodynamic retarder 6 is actuated, according to the brake position, a large amount of oil from the first piston space 11 is introduced in the retarder space 9, the brake torque being controlled and regulated via the degree of admission of the retarder 6 or of the retarder space 9. In the operation of the automatic transmission, the rotor 7 is in the power flow while the stator 8 is fixedly connected with a retarder housing 13. The rotating rotor 7 takes along the oil, via impellers (not shown), the oil supporting itself on the stator 8 and thus producing a braking effect upon the rotor shaft.

When the retarder 6 is not actuated, the step piston 10 abuts on a first stop 14 remote from the rotor 7 and is here component part of the retarder housing 13. The second piston space 12 or the volume content thereof is reduced almost to zero and a pressure prevalent in the second piston space 12 corresponds nearly to an enveloping pressure of the automatic transmission.

If a signal corresponding to a build up of a brake torque exists in the retarder 6, the valve 3 is controlled so that a connection is created between the pump 2 and the second piston space 12 via the valve 3. The pump 2 makes a system pressure of the automatic transmission available or of the hydraulic system 1 which produces a displacement of the step piston 10 in direction of the rotor 7. This displacement results in a reduction of the volume of the first piston space 11 and simultaneously an increase of the degree of admission of the retarder space 9.

As result of the aspect ratio of the bottom surfaces of the first piston space 11 and of the second piston space 12, a smaller amount of oil corresponding to the ratio is needed to fill the retarder space 9 whereby the pump 2 can be dimensioned accordingly small. The pressure building up in the second piston space 12 for displacing the step piston 10 has to overcome, a tension of a recoil spring 15 situated in the first piston space 11 and a pressure existing in the first piston space 11, in addition to the frictional forces produced by the fluid friction in the connection between the first piston space 11 and the retarder space 9.

In the embodiment shown, the valve 3 is designed as shift valve. During actuation of the retarder 6, the step piston 10 is displaced up to a second stop 16 so that the degree of admission of the retarder space 9 is raised to a specific value by the displacement of the step piston 10. The regulation of the degree of admission of the retarder space 9 is carried out here via a proportional pressure-regulating valve (not shown in detail), which is connected with the hydraulic system 1 and directly with the retarder space 9. This means that a controlled quick filling of the retarder space 9 is first effected, via the step piston 10, and one other adjustment or regulation of the brake torque of the retarder 6 is carried out via the proportional pressure-regulating valve. The retarder space 9 and the hydraulic system 1 thus have a common oil circuit.

Alternatively to this it can be provided to design the valve 3 as a regulating valve and through it to control and regulate the step piston 10. Here the displacement valve of the step piston 10 or the volume of the first piston space 11 is dimensioned so that the step piston 10 does not reach the second mechanical stop 16 but is in normal position during the actuation of the retarder 6 wherein, depending on a required brake torque between the first stop 14 and the second stop 16, it oscillates between the first stop 14 and the second stop 16 or is kept in a certain position between both stops 14 and 16. An additional regulation of the degree of admission of the retarder space 9, via a proportional pressure-regulating valve, can be omitted. The retarder 6 and the degree of admission of the retarder space 9 are regulated and controlled via the valve 3 alone even in case of separate oil supply of the retarder 6 from the oil supply of the automatic transmission or from the hydraulic system 1.

In both variants, when the retarder 6 opens, a connection is created via the valve 3 between the second piston space 12 and the oil reservoir 4 so that the step piston 10 is displaced by the recoil spring 15 in direction of the first stop 14. Due to the enlargement of the volume of the first piston space 11, a suction effect, which assist the draining of the retarder space 9, generates in the first piston space 11.

This invention can be applied respectively to a primary retarder disposed on the engine side or also to a secondary retarder situated on the transmission side in the drive line of a vehicle. Thus there results on the vehicle wheels, for example, for a primary retarder when the retarder 6 is actuated, an exact and quick adjustable gear-dependent brake torque which increases proportionally to the ratio as the gear become lower. Thus, the primary retarders operated with the inventive hydraulic system 1 or the inventive step piston 10 are effective already at low vehicle speeds and produces relatively strong brake torques on the drive wheels.

Reference numerals

| | |
|---|---|
| 1 | hydraulic system |
| 2 | pressure source, pump |
| 3 | valve, shift valve, regulating valve |
| 4 | oil reservoir |
| 5 | pipe |
| 6 | hydrodynamic retarder |
| 7 | rotor |
| 8 | stator |
| 9 | retarder space |
| 10 | step piston |
| 11 | first piston space |
| 12 | second piston space |
| 13 | retarder housing |
| 14 | first stop |
| 15 | recoil spring |
| 16 | second stop |

1. Automatic transmission with a hydraulic system (1) for control and regulation of a hydrodynamic retarder (6) which has a retarder space (9) formed between a rotor (7) and a stator (8), characterized in that a degree of admission of said retarder space (9) can be altered according to a position of a hydraulic ratio (10, 11, 12) connected with said retarder space (9).

2. Automatic transmission according to claim 1, characterized in that said hydraulic ratio is designed with a step piston (10) which defines a first piston space (11) with large bottom surface and as second piston space (12) with smaller bottom surface, said first piston space (11) being connected with said retarder space (9).

3. Automatic transmission according to claim 2, characterized in that said first piston space (11) borders on the side of said rotor (7) remote from said retarder space (9).

4. Automatic transmission according to claim 2 or 3, characterized in that to reduce the degree of admission of said retarder space (9), a recoil spring (15) is provided which acts upon said step piston (10).

5. Automatic transmission according to any one of claims 2 to 4, characterized in that said first piston space (11) is designed as hydraulic reservoir and said step piston (10) is movable for adjusting the degree of admission of said retarder space (9) up to a stop disposed in the area of said rotor (7).

6. Automatic transmission according to any one of claims 2 to 5, characterized in that said second piston space (12) is controlled via a shift valve (3) connected with said hydraulic system (1).

7. Automatic transmission according to any one of claims 1 to 6, characterized in that the degree of admission of said retarder space (9) is regulated via a proportional pressure-regulating valve connected with said hydraulic system 1.

8. Automatic transmission according to any one of claims 1 to 7, characterized in that said retarder space (9) and said hydraulic system (1) have a common oil circuit.

9. Automatic transmission according to any one of claims 2 to 5, characterized in that during control and regulation of the degree of admission of said retarder space (9), said step piston (10) can be retained in a position between a first stop (14) and a second stop (16).

10. Automatic transmission according to claim 9, characterized in that said second piston space (12) is controlled and regulated via a regulating valve (3) connected with said hydraulic system (1).

11. Automatic transmission according to claim 9 or 10, characterized in that said hydraulic system (1) and said retarder space (9) have separate oil circuits.
